(19) United States
(12) Patent Application Publication
(10) Pub. No.: US 2025/0109504 A1
(43) Pub. Date: Apr. 3, 2025

(54) HETEROCYCLIC NON-TRIAZOLE COMPOUNDS AND METHODS FOR INHIBITING CORROSION IN INDUSTRIAL WATER TREATMENT

(71) Applicant: CHEMTREAT, INC., Glen Allen, VA (US)

(72) Inventors: Santanu BANERJEE, Glen Allen, VA (US); Patrick Wood, Midlothian, VA (US); Rajendra Prasad Kalakodimi, Glen Allen, VA (US); William Henderson, Richmond, VA (US)

(73) Assignee: CHEMTREAT, INC., Glen Allen, VA (US)

(21) Appl. No.: 18/899,344

(22) Filed: Sep. 27, 2024

Related U.S. Application Data
(60) Provisional application No. 63/541,425, filed on Sep. 29, 2023.

(51) Int. Cl. C23F 11/14; C23F 11/18

(52) U.S. Cl. CPC C23F 11/149; C23F 11/18

(57) ABSTRACT

Methods of treating aqueous systems with treatment compositions including non-triazole compounds are provided that are effective to inhibit corrosion of corrodible metal surfaces in the aqueous systems. The non-triazole compounds show comparable or better corrosion inhibition as compared to conventional triazole corrosion inhibitors, and have low toxicity and good stability in the presence of halogens such as halogen-containing biocides or free chlorine.

### CROSS-REFERENCE TO RELATED APPLICATION

This application claims the earlier filing date benefit of U.S. Provisional Application No. 63/541,425, filed on Sep. 29, 2023, the entirety of which is incorporated by reference herein.

### TECHNICAL FIELD

This application relates generally to heterocyclic non-triazole compounds and their use as corrosion inhibitors to inhibit corrosion in industrial water systems including mixed metal systems.

### BACKGROUND

Corrosion of metal surfaces in water systems is a serious problem. Corrosion can cause undesirable consequences, including loss of heat transfer, increased cleaning frequency, equipment repairs and replacements, shutdowns, environmental problems and the increasing resources and costs associated with each. Some causes of increased corrosion of metal surfaces include high dissolved solids, acidic environments, elevated temperatures, microbiological growth, organic and mineral deposits, and fluids that contain relatively high concentration of gases such as oxygen, hydrogen sulfide, or carbon dioxide.

Ferrous metals such as stainless steel are commonly used in industrial water systems such as for heat exchangers in cooling waters. Stainless steel has good mechanical and physical properties for long service life, as well as generally good corrosion resistance. However, even stainless steel can be subject to pitting and crevice corrosion.

Copper and its alloys (all referred to generally as “yellow metals”) are also commonly used in cooling water treatment systems for heat exchanger tubing, pump impellers, and various other applications due to the natural corrosion resistance and high thermal conductivity of these metals. However, copper and its alloys are not immune to corrosion in cooling water applications especially in the presence of halogen based oxidizing biocides such as hypochlorous acid (HOCl) or hypobromous acid (HOBr), which results in corrosion and possibly failure of heat exchangers. Current corrosion inhibitors for copper and its alloys include triazole-based compounds, i.e., a heterocyclic compound that includes a five-membered ring of two carbon atoms and three nitrogen atoms. Conventional triazole corrosion inhibitors include tolyltriazole (TT), benzotriazole (BZT), and chlorinated tolyltriazole (CI-TT). The triazoles work as yellow metal corrosion inhibitors by forming an inhibitor film on the surface of yellow metals through bonding with copper. However, the film formed by triazoles can be disrupted by halogen-based biocides (e.g., HOCl), which can lead to corrosion and equipment failure. The film formed by triazoles on the metal surface is also affected by high free chlorine and it requires additional triazole to re-passivate the film for corrosion protection. Additionally, in the bulk water, the triazole inhibitor can react and be degraded by halogen-containing biocide and its corrosion inhibition capacity reduced. Triazole inhibitors and their halogenated derivatives also have high aquatic toxicity which can limit their application in industrial cooling water treatment, and the raw materials required to manufacture triazoles are often impacted by cost fluctuation and supply chain vulnerability.

Use of benzimidazoles and polymeric acids for inhibiting corrosion in aqueous systems including yellow metal surfaces is known. For example, U.S. Pat. No. 10,202,694 (“Rane”) is directed to inhibiting corrosion of a metal surface in contact with an aqueous system using 2-substituted imidazoles and 2-substituted benzimidazoles. Rane discloses a formulation for inhibiting corrosion of a metal surface in contact with an aqueous system comprising an oxidizing halogen compound and having a pH of from about 6 to about 12, the formulation comprising a compound of formula (I) or (II), a phosphoric acid, and a phosphinosuccinic oligomer, wherein formula (I) is

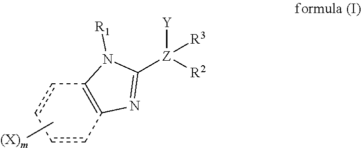

wherein each X is the same or different, and is selected from the group consisting of hydrogen, C₁-C₁₆ alkyl, aryl, C₂-C₁₆ alkenyl, C₂-C₁₆ alkynyl, heteroaryl, C₃-C₈ cycloalkyl, benzyl, alkylheteroaryl, halogen, halosubstituted alkyl, amino, aminoalkyl, cyano, alkoxy, hydroxyl, thiol, alkylthio, carbonyl, nitro, phosphoryl, phosphonyl, and sulfonyl; Y is selected from the group consisting of hydroxyl, halogen, oxo, alkoxy, thiol, alkylthio, amino, hydrogen, and aminoalkyl; Z is selected from the group consisting of carbon and nitrogen; R1 is selected from the group consisting of hydrogen, deuterium, C₁-C₁₆ alkyl, aryl, C₂-C₁₆ alkenyl, C₂-C₁₆ alkynyl, heteroaryl, C₃-C₈ cycloalkyl, benzyl, alkylheteroaryl, halogen, hydroxyl, and carbonyl; R² and R³ are selected from the group consisting of hydrogen, halogen, hydroxyl, aryl, phenyl, heteroaryl, benzyl, alkylheteroaryl, carbonyl, C₂-C₁₆ alkenyl, C₂-C₁₆ alkynyl, C₃-C₈ cycloalkyl, and C₁-C₁₆ alkyl; and m is 1, 2, 3, or 4; or a salt thereof, and formula (II) is

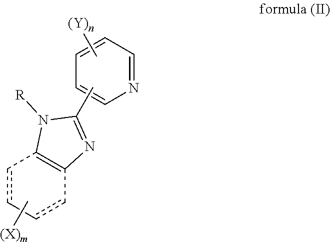

wherein each of X and Y is the same or different and is selected from the group consisting of hydrogen, C₁-C₁₆ alkyl, aryl, C₂-C₁₆ alkenyl, C₂-C₁₆ alkynyl, heteroaryl, C₃-C₈ cycloalkyl, benzyl, alkylheteroaryl, halogen, halosubstituted alkyl, amino, aminoalkyl, cyano, alkoxy, hydroxyl, thiol, alkylthio, carbonyl, nitro, phosphoryl, phosphonyl, and sulfonyl; R is selected from the group consisting of hydrogen, deuterium, C₁-C₁₆ alkyl, aryl, C₂-C₁₆ alkenyl, C₂-C₁₆ alkynyl, heteroaryl, C₃-C₈ cycloalkyl, benzyl, alkylheteroaryl, halogen, hydroxyl, and carbonyl; m is 1, 2, 3, or 4; or n is 1, 2, 3, or 4; or a salt thereof.

U.S. Pat. No. 11,572,628 (“Xie”) discloses a method of reducing corrosion of copper and copper alloy equipment in aqueous systems that includes adding a compound of formula (I) or salt thereof,

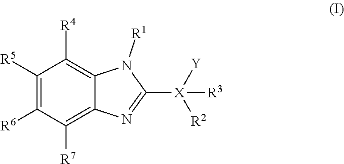

where R¹ can be halo, hydrogen, deuterium, hydroxyl, carbonyl, substituted or unsubstituted C₁-C₁₆ alkyl, substituted or unsubstituted C₄-C₆ aryl, substituted or unsubstituted C₂-C₁₆ alkenyl, substituted or unsubstituted C₂-C₁₆ alkynyl, substituted or unsubstituted C₄-C₆ heteroaryl, or substituted or unsubstituted C₃-C₈ cycloalkyl; X can be absent, CR²R³Y, or NR²R³Y; Y can be hydroxyl, halo, oxo, substituted or unsubstituted C₁-C₁₆ alkoxy, thiol, alkylthio, amino, hydrogen, or aminoalkyl; R² and R³ can be each independently selected from the group consisting of: hydrogen, halo, hydroxyl, substituted or unsubstituted C₄-C₆ aryl, substituted or unsubstituted C₄-C₆ heteroaryl, carbonyl, substituted or unsubstituted C₂-C₁₆ alkenyl, substituted or unsubstituted C₂-C₁₆ alkynyl, substituted or unsubstituted C₃-C₆ cycloalkyl, and substituted or unsubstituted C₁-C₁₆ alkyl; and R⁴, R⁵, R⁶, and R⁷ can be each independently selected from the group consisting of: hydrogen, halo, amino, aminoalkyl, cyano, substituted or unsubstituted C₁-C₁₆ alkoxy, hydroxyl, thiol, carbonyl, nitro, phosphoryl, phosphonyl, sulfonyl, substituted or unsubstituted C₁-C₁₆ alkyl, substituted or unsubstituted C₄-C₆ aryl, substituted or unsubstituted C₂-C₁₆ alkenyl, substituted or unsubstituted C₂-C₁₆ alkynyl, substituted or unsubstituted C₄-C₆ heteroaryl, and substituted or unsubstituted C₃-C₈ cycloalkyl, provided that at least one of R⁴, R⁵, R⁶, and R⁷ is hydrogen.

US 2022/0127730 (“Chen”) is directed to water treatment compositions comprising a cathodic inhibitor comprising at least one rare earth metal, an anodic inhibitor comprising at least one polycarboxylic acid, and a polymer dispersant comprising at least one sulfonic group. The polymer dispersant may include 4,5-imidazoledicarboxylic acid.

However, these references do not contemplate use of benzimidazoles and polymeric acids such as 4,5-imidazoledicarboxylic acid in combination with light metal corrosion inhibitors. Moreover, conventional treatment methods involve solubilizing corrosion inhibitors in sodium hydroxide (NaOH). Solubility of benzimidazoles and polymeric acids such as 4,5-imidazoledicarboxylic acid in NaOH is low, i.e., less than 2%. The above references do not contemplate means for addressing the problem of low solubility. These and other issues are addressed by the present disclosure.

### SUMMARY

According to one aspect, this disclosure provides a method of inhibiting corrosion of a corrodible metal surface that contacts a water stream in a water system. The method includes introducing into the water stream a treatment composition including at least one light metal corrosion inhibitor, and at least one non-triazole compound that is selected from a compound that is represented by Formula (I) or Formula (II) below:

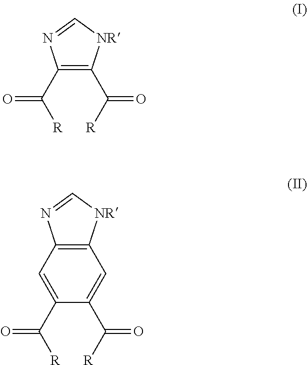

in which R is H, OX, or NX₂, X is H, C₁-C₁₂, Cl, or Br, and R′ is H, Cl, or Br.

According to another aspect, this disclosure provides a method of inhibiting corrosion of a corrodible metal surface that contacts a water stream in a water system. The method includes introducing into the water stream a treatment composition including at least one non-triazole compound that is selected from a compound that is represented by Formula (I) or Formula (II). The at least one non-triazole compound is solubilized in the treatment composition with potassium hydroxide.

According to another aspect, this disclosure provides a corrosion inhibition composition. The composition includes at least one light metal corrosion inhibitor, at least one non-triazole compound that is selected from a compound that is represented by Formula (I) or Formula (II), and potassium hydroxide. The at least one non-triazole compound is solubilized in the treatment composition with the potassium hydroxide.

### BRIEF DESCRIPTION OF THE DRAWINGS

FIG. 1 is a graph showing the corrosion of a copper alloy surface when treated with non-triazole corrosion inhibitors and conventional triazole corrosion inhibitors;

FIG. 2 is a graph showing the corrosion of a copper alloy surface when treated with non-triazole corrosion inhibitors and conventional triazole corrosion inhibitors;

FIG. 3 is a graph showing the corrosion of a copper alloy surface when treated with non-triazole corrosion inhibitors and conventional triazole corrosion inhibitors; and

FIG. 4 is a graph showing the corrosion of a copper alloy surface when treated with non-triazole corrosion inhibitors and conventional triazole corrosion inhibitors.

### DETAILED DESCRIPTION

This disclosure provides novel heterocyclic non-triazole chemistries that are effective to prevent corrosion of metal surfaces in contact with water. The heterocyclic non-triazole corrosion inhibitors overcome several of the drawbacks of known triazole-based corrosion inhibitors. In particular, disclosed heterocyclic non-triazole corrosion inhibitors have been shown to perform as better corrosion inhibitors for metal surfaces than conventional compounds used in cooling water corrosion inhibition application.

### Treatment Compounds

In embodiments, the heterocyclic non-triazole compound can be an imidazole represented by Formula (I) below.

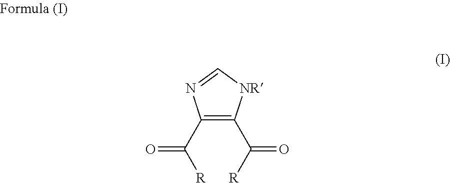

In Formula (I), R may be H, OX, or NX₂, X may be H, a hydrocarbon group, Cl, or Br, and R′ may be H, Cl, or Br. The hydrocarbon group can be linear, branched, cyclic or heterocyclic, aliphatic or aromatic, saturated or unsaturated. The hydrocarbon group can include from 1 to 20 carbon atoms, from 1 to 12 carbon atoms, or from 4 to 7 carbon atoms, for example. The hydrocarbon group can include one or more of the following atoms/moieties: halogen, heteroatom, amino, aminoalkyl, cyano, alkoxy, hydroxyl, polyhydroxyl, thiol, alkythiol, carbonyl, nitro, phosphoryl, phosphonyl, sulfonyl. If non-cyclic, the hydrocarbon can be terminated with an amine or hydroxyl group. If the hydrocarbon group includes heteroatoms, the heteroatoms can be present in the hydrocarbon backbone in numbers of, for example, 1, 2, 3, or 4 heteroatoms, including, e.g., N, O, S, and the hydrocarbon group can also be substituted with a halogen atom. If aromatic groups are present, they can include heterocyclic aromatic groups, including a pyridine group, for example.

The N may be a substituted or substituted amine. Exemplary amine compounds that can be used include primary amines, secondary amines, diamines (e.g., dimethylaminopropylamine), triamines (e.g., diethylene triamine), cyclic or heterocyclic amines (e.g., morpholine), ethoxyamines (e.g., 3-methoxy propyl amine), alkanolamines (e.g., aminoethyl ethanolamine), polyhydroxy amines (e.g., glucamine), imidazolidinones (e.g., 1-(2-hydroxyethyl)-2-imidazolidinone), imidazolines, imidazole, pyrazoles, piperazines (e.g., 1-(2-hydroxyethyl) piperazine), piperidines, and pyrrolidines.

The compound of Formula (I) does not include any triazole groups, and preferably does not include any tetrazole groups.

In embodiments, the heterocyclic non-triazole compounds can be a benzimidazole represented by Formula (II) below.

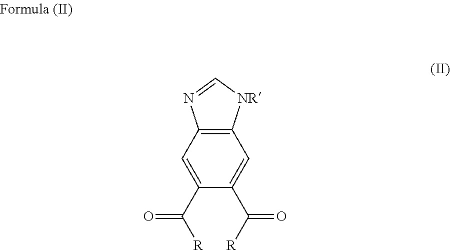

In Formula (II), R may be H, OX, or NX₂, X may be H, a hydrocarbon group, Cl, or Br; and R′ may be H, Cl, or Br. The hydrocarbon group can be linear, branched, cyclic or heterocyclic, aliphatic or aromatic, saturated or unsaturated. The hydrocarbon group can include from 1 to 20 carbon atoms, from 1 to 12 carbon atoms, or from 4 to 7 carbon atoms, for example. The hydrocarbon group can include one or more of the following atoms/moieties: halogen, heteroatom, amino, aminoalkyl, cyano, alkoxy, hydroxyl, polyhydroxyl, thiol, alkythiol, carbonyl, nitro, phosphoryl, phosphonyl, sulfonyl. If non-cyclic, the hydrocarbon can be terminated with an amine or hydroxyl group. If the hydrocarbon group includes heteroatoms, the heteroatoms can be present in the hydrocarbon backbone in numbers of, for example, 1, 2, 3, or 4 heteroatoms, including, e.g., N, O, S, and the hydrocarbon group can also be substituted with a halogen atom. If aromatic groups are present, they can include heterocyclic aromatic groups, including a pyridine group, for example.

The N may be a substituted or substituted amine. Exemplary amine compounds that can be used include primary amines, secondary amines, diamines (e.g., dimethylaminopropylamine), triamines (e.g., diethylene triamine), cyclic or heterocyclic amines (e.g., morpholine), ethoxyamines (e.g., 3-methoxy propyl amine), alkanolamines (e.g., aminoethyl ethanolamine), polyhydroxy amines (e.g., glucamine), imidazolidinones (e.g., 1-(2-hydroxyethyl)-2-imidazolidinone), imidazolines, imidazole, pyrazoles, piperazines (e.g., 1-(2-hydroxyethyl) piperazine), piperidines, and pyrrolidines.

The compound of Formula (II) does not include any triazole groups, and preferably does not include any tetrazole groups.

In embodiments, the non-triazole compound may be halogenated imidazole, imidazole dicarboxylate, halogenated benzimidazole, or benzimidazole dicarboxylate.

### Treatment Methods

The at least one non-triazole compound described above can be combined with water that is in contact with a metal surface to inhibit or prevent corrosion of the metal surface. In embodiments, the non-triazole compound may be introduced into open or closed water systems. Further, the non-triazole compound can be applied to the water stream while the water system is on-line. The methods of inhibiting corrosion can be used in aqueous systems including, but not limited to cooling water, cooling towers, water distribution systems, boilers, pasteurizers, water and brine carrying pipelines, storage tanks and the like. In general, water in these aqueous systems is at least 90 wt. % water, at least 95 wt. % water, or at least 99 wt. % water.

The water systems may be mixed metal systems. In embodiments, mixed metal systems include systems that include surfaces of two or more metals such as copper or copper alloy metal surfaces and another metal. The other metals may include, but are not limited to, iron, silver, steel, zinc alloy, and aluminum. In embodiments, the other metal may be stainless steel, ferrous steel, and/or galvanized steel.

The water in the aqueous systems may contain a free halogen residual in amounts of from 0 to 20 ppm, from 0.01 to 10 ppm, from 0.1 to 5 ppm, or from 0 to 2 ppm, for example. The water temperature may be from 0 to 200° C., from 0 to 180° C., from 0 to 140° C., from 1 to 120° C., from 1 to 100° C., from 20 to 70° C., from 40 to 60° C., or about 50° C. The water in the aqueous systems may be pressurized. The pH of the water may have a value of from 2 to 12, from 4 to 10, from 6 to 9, from 7.0 to 8.5, from 7.5 to 8.5, or about 8.

The at least one non-triazole compound described above can be combined with the water in the water system in amounts that are effective to form a film of the non-triazole compound(s) on the metal surface and reduce corrosion of the metal surface to a desired degree. The at least one non-triazole compound can be added so that the non-triazole compound is present in the water in amounts of from 0.01 ppm to 500 ppm, 0.1 ppm to 100 ppm, from 0.5 ppm to 100 ppm, from 1 ppm to 50 ppm, or from 2 ppm to 15 ppm, for example. The non-triazole compounds can be added to the water continuously, periodically, or intermittently.

In embodiments, the non-triazole inhibitors exhibit high solubility when solubilized with potassium hydroxide (KOH) as a base. In the treatment composition, the non-triazole inhibitors may be, for example, in a range of more than 3 to 60%, 3.1 to 50%, 3.5 to 40%, 4 to 35%, 5 to 30%, 5 to 20%, 5 to 15%, or 10 to 15%, solubilized in KOH.

In embodiments, a light metal corrosion inhibitor may be added along with the at least one non-triazole compound in the treatment composition. For purposes of this disclosure, a “light metal” refers to metals listed in Groups 4-14 and Periods 4-7 of the periodic table. The light metal corrosion inhibitor may be a salt of one or more of Sn, Mn, Zn, Mo, W, and Al. In preferred embodiments, the light metal corrosion inhibitor is a Sn, Al, and/Zn salt. Stannous corrosion inhibitors particularly suitable for use with the disclosed methods include Tin (II) and aluminum compounds. Tin (II) is more soluble in aqueous solutions than a higher oxidation state metal ion, such as Tin (IV). The corrosion inhibitor may be provided as a stannous salt selected from the group consisting of stannous sulfate, stannous bromide, stannous chloride, stannous oxide, stannous phosphate, stannous pyrophosphate, and stannous tetrafluroborate. The light metal corrosion inhibitor may be added so that amounts of the light metal corrosion inhibitor in the water stream are from 0.01 ppm to 500 ppm, 0.01 ppm to 100 ppm, from 0.01 to 50 ppm, for example. The inventors found that non-triazole corrosion inhibitors in combination with light metal corrosion inhibitors (e.g., Sn/Al/Zn compositions) result in particularly synergistic corrosion inhibition. The inventors found this combination to be particularly synergistic when applied in mixed metal systems.

In embodiments, the treatment composition may exclude cathodic corrosion inhibitors including, but not limited, to rare earth metals.

The compounds can be added in response to a measured parameter of the water or of the metal surface, including when a measured amount of corrosion inhibitor drops below a predetermined threshold. The compounds can be added in response to a system demand of the system or surface demand of the metal surface.

System demand may be attributed to the presence of oxygen, halogens, other oxidizing species and other components in the aqueous system that can react with or remove, and thereby deactivate or consume, the inhibitor. System demand also includes inhibitor losses associated with bulk water loss through, for example, blowdown and/or other discharges from the treated system. System demand does not, however, include inhibitor that binds to or otherwise reacts with the wetted metal surfaces.

Surface demand is the consumption of the inhibitor attributed to the interaction between the inhibitor and a reactive metal surface. Surface demand will decline as the inhibitor forms a protective film or layer on those metal surfaces that were vulnerable to corrosion. Once all of the wetted surfaces have been adequately protected, the surface demand will be nothing or almost nothing. Because the intermittent feed methods according to embodiments focus on treating the metal rather than treating the water, once the surface demand is reduced to values close to zero, the inhibitor feed amount can be substantially reduced or even terminated for some period of time without compromising the effectiveness of the corrosion inhibition program.

The non-triazole compounds can be added to the water in the form of a powder or an aqueous solution. If added as an aqueous solution, the non-triazole compound can be present in amounts of from 1 to 60 wt. % or from 5 to 40 wt. %, for example.

The metal surface that is in contact with the treated water can include ferrous metals such as steel (e.g., mild steel, stainless steel, galvanized steel, etc.), aluminum and its alloys, and yellow metals (e.g., copper and copper-based alloys including bronzes, brasses, etc.). In one aspect, it has been discovered that non-triazole compounds are particularly useful in inhibiting corrosion of yellow metals. In this regard, the non-triazole compounds, and in particular compounds of Formulas (I) and (II) and derivatives, can prevent corrosion on yellow metals by forming an insoluble protective film on the surface. It is believed that the film is stabilize by a molecular bond with the organic inhibitor and copper and prevents surface interaction with corrosive species.

The non-triazole inhibitors have improved aquatic toxicity, as compared to conventional azole inhibitors. Accordingly, in some embodiments, the treated water that is in contact with the metal surface is free of or substantially free of triazole compounds, e.g., less than 5 ppm triazole compounds, less than 1 ppm triazole compounds, or less than 0.1 ppm triazole compounds. In particular, the treated water can be free of or substantially free of tolyltriazole, benzotriazole, and chlorinated tolyltriazole.

In some embodiments, the non-triazole inhibitors can be added to the water in combination with other inhibitor treatment agents including triazoles, polymers, phosphonates, and/or phosphates.

The non-triazole corrosion inhibitors also have improved halogen stability, and remain effective to inhibit corrosion even in the water that contains halogen-containing biocides or free chlorine. In this regard, it is believed that these halogens do not substantially disrupt the film formed by the above-referenced non-triazole corrosion inhibitors and do not degrade those compounds in the bulk water. Accordingly, in some embodiments, the treated water that is in contact with the metal surface includes at least 0.1 ppm of a halogen-containing biocide and/or free chlorine, at least 0.5 ppm, at least 1 ppm, or from 1 ppm to 10 ppm. Halogen-containing biocides may include, for example, hypochlorous acid or hypobromous acid. Likewise, in some embodiments, methods include combining a halogen-containing biocide with the treated water in addition to the non-triazole compound.

In addition to the non-triazole corrosion inhibitor, other components can be added to the water as part of the treatment, including chelating agents, scale inhibitors, dispersants, biocides (such as the halogen-containing biocide noted above), and combinations thereof. These components can be included as part of a treatment composition with the non-triazole corrosion inhibitor or can be added to the water separately. Suitable chelating agents include, for example, citric acid, 2-butenedioic acid (Z), and their derivatives. Suitable scale inhibitors and dispersants can include one or more of unsaturated carboxylic acid polymers such as polyacrylic acid, homo or co-polymaleic acid (synthesized from solvent and aqueous routes); acrylate/2-acrylamido-2-methylpropane sulfonic acid (APMS) copolymers, copolymer of maleic and acyclic acid (MA/AA), acrylate/acrylamide copolymers, acrylate homopolymers, terpolymers of carboxylate/sulfonate/maleate, terpolymers of acrylic acid/AMPS; phosphonates and phosphinates including 2-phosphonobutane-1,2,4-tricarboxylic acid (PBTC), 1-hydroxy ethylidene-1,1-diphosphonic acid (HEDP), amino tris methylene phosphonic acid (ATMP), 2-hydroxyphosphonocarboxylic acid (HPA), diethylenetriamine penta(methylene phosphonic acid) (DETPMP), bis(hexamethylene triamine penta (methylene phosphonic acid) (BHMTPMP), phosphinosuccinic oligomer (PSO), tetrapotassium pyrophosphate (TKPP), phosphoric acid; salts of molybdenum and tungsten including nitrates and nitrites; amines such as N,N-diethylhydroxylamine (DEHA), diethyl amino ethanol (DEAE), dimethylethanolamine (DMAE), cyclohexylamine, morpholine, and monoethanolamine (MEA). The other components can be added so that the components are present in the water in amounts of from 0.01 ppm to 500 ppm, 0.01 ppm to 100 ppm, from 0.01 to 50 ppm, for example.

In some embodiments, at least one triazole compound such as tolyltriazole (TTA), benzotriazole (BZT), methylbenzotriazole (MBT), butylbenzotriazole (BuBZT), halogen-stable azole (HST), halogenated azoles, and their salts, may be added. The at least one triazole compound can be added so that the triazole compound is present in the water in amounts of from 0.01 ppm to 5 ppm, 0.01 ppm to 1 ppm, from 0.01 to 0.50 ppm, for example. The non-triazole compound is dosed in greater amounts than the triazole. In embodiments, the at least one non-triazole compound and the at least one triazole compound may be present in the water in a mass ratio of from 1,000:1 to 50:1, from 500:1 to 100:1, from 300:1 to 100:1, from 250:1 to 150:1, or about 200:1, for example. The inventors found that non-triazole corrosion inhibitors in combination with low active triazole compounds result in particularly synergistic corrosion inhibition. The inventors found that the triazole may be added in small amounts and result in synergy while still obtaining the benefit of less toxicity. This combination is synergistic and can be done with substantially reduced aquatic toxicity as compared to using triazoles alone to achieve the same level of corrosion inhibition.

In some embodiments, a sugar acid may be added. The sugar acids may include, but are not limited to, glucaric acid, gluconic acid, glucoheptonate, citric/poly citric acid, ascorbic acid, erythorbic acid, glycolic acid, adipic acid, aqueous and a solvent based polymaleic acid. These acids may be added so that amounts of these acids in the water stream are from 0.01 ppm to 100 ppm, 0.01 ppm to 50 ppm, from 1 to 10 ppm, or from 1 to 5 ppm, for example.

In some embodiments, a nitrite, molybdate, silicate, or borate compound may be added. These compounds may be added so that amounts of these compounds in the water stream are from 0.01 ppm to 100 ppm, 0.01 ppm to 50 ppm, from 1 to 10 ppm, or from 1 to 5 ppm, for example. The inventors found that the combination of the non-triazole corrosion inhibitor and nitrite, molybdate, silicate, or borate compound is particularly beneficial in closed loop systems.

In some embodiments, one or more fluorescent agents can be combined with the non-triazole inhibitor or added to the water together with the non-triazole inhibitor to detect and quantify the amount of inhibitor in the water. In embodiments, the fluorescent agents can include a reactive chemical tracer (e.g., PTSA) that interacts with the non-triazole group in a way that affects the fluorescence intensity and a non-reactive chemical tracer such as a tagged polymer. Suitable fluorescent agents that can be used are described in U.S. Pat. No. 10,024,751, the entirety of which is incorporated by reference herein.

### EXAMPLES

Several classes of compounds at various concentrations were tested to determine their potential to inhibit corrosion of copper alloy in aqueous systems to determine their potential to inhibit corrosion of copper alloy in aqueous systems as shown in Table 1 below.

TABLE 1

| Water | Blank/Control |
|---|---|
| Tolyltriazole | TTA |
| Halogen stable triazole | HST |
| Free active chlorine | FAC |
| Imidazole dicarboxylate | IMDCC |
| Tin/Al corrosion treatment 1 | CT1 |
| Tin/Al corrosion treatment 2 | CT2 |

1 liter samples of synthetic water were each dosed with 5 ppm of a different glucamide compound (A, B, C, D) according to Formula (I) above and 50 ppm of a standard scale inhibitor. Another 1 liter sample of synthetic water was dosed with 4 ppm of tolyltriazole and 50 ppm of the standard scale inhibitor product. The composition of the synthetic water is shown in Table 2 below.

TABLE 2

| | |
|---|---|
| pH | 7.9 |
| Ca as CaCO₃ | 600 ppm |
| Mg as CaCO₃ | 300 ppm |
| Sulfate | 600 ppm |
| Malk as CaCO₃ | 75 ppm |
| Silica as SiO₂ | 10 ppm |
| Chloride | 430 ppm |

The apparatus used for the corrosion testing was a Gamry Multiport Corrosion Cell and Gamry Reference 600+ potentiostat with multiplexor. Copper coupons (CDA110) were added to the sample cells, and the cells were heated to 50° C. and maintained at this temperature throughout the testing. The cells were continuously stirred at a speed of 350 rpm. A cylindrical working electrode was submerged into the test solutions, and an LPR sweep (linear polarization resistance) was performed every hour for 18 hours. After the one hour mark, 1 ppm of free chlorine was dosed into the corrosion cell. The testing parameters are summarized in Table 3 below.

TABLE 3

| | |
|---|---|
| Temperature | 50° C. |
| Free Chlorine Dosage | 1 ppm after 1 hr |
| Metallurgy | CDA110 |
| Product Dosage (unless otherwise notes) | 5 ppm |
| Duration | 18 hrs |
| Stirring Speed | 350 rpm |

### Example 1

The classes of compounds and concentrations tested in this example are as shown in Table 4 below.

TABLE 4

| Blank | |
|---|---|
| HST | 0.5 ppm |
| HST | 0.25 ppm |
| HST | 0.1 ppm |
| TTA | 0.5 ppm |
| IMDCC | 5 ppm |
| IMDCC | 2.5 ppm |
| IMDCC | 1 ppm |
| FAC | 1 ppm |

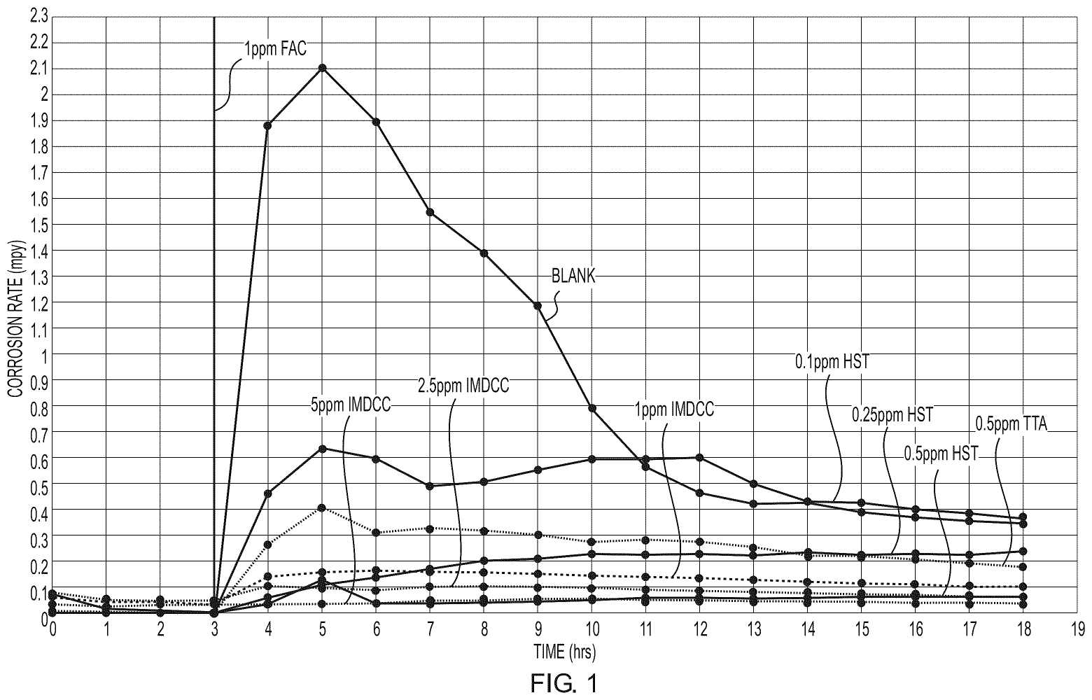

The corrosion rates (in mpy) over the 18 hour period are shown in FIG. 1. As can be seen, the IMDCC compounds exhibit superior corrosion inhibition properties over the entire 18 hour period as compared to the triazole inhibitors. And, unlike the triazole inhibitor, the IMDCC corrosion inhibitors do not exhibit any substantial deterioration in corrosion resistance when free chlorine is added.

### Example 2

The classes of compounds and concentrations tested in this example are as shown in Table 5 below.

TABLE 5

| Blank | |
|---|---|
| HST | 0.5 ppm |
| CT1 | 100 ppm |
| IMDCC | 1 ppm |
| CT1 + IMDCC | 100 ppm + 1 ppm |
| FAC | 1 ppm |

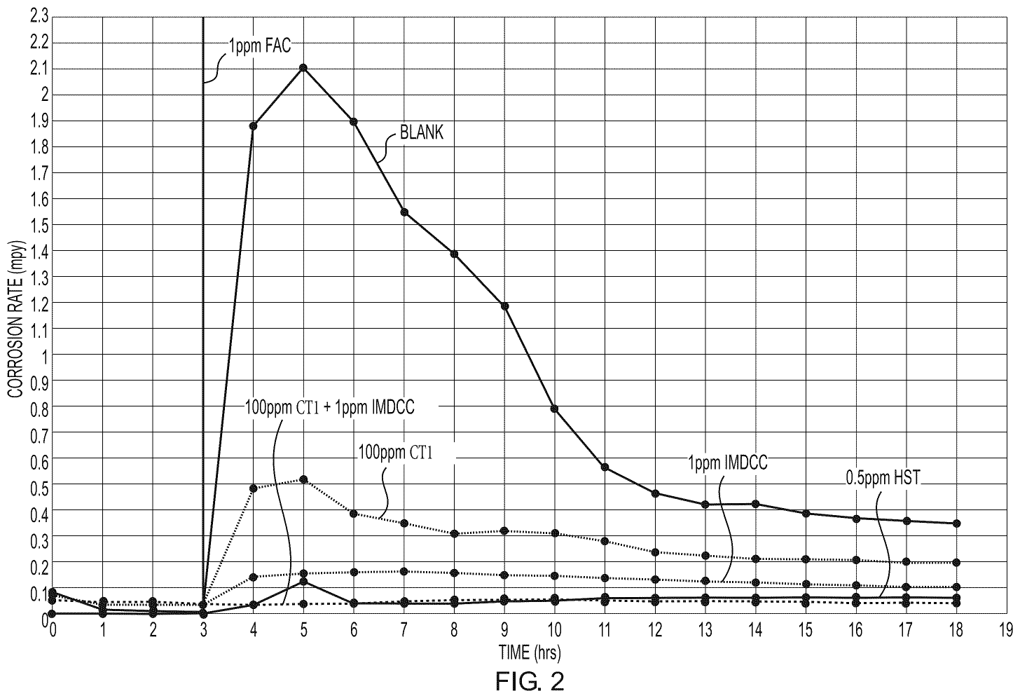

The corrosion rates (in mpy) over the 18 hour period are shown in FIG. 2. As can be seen, the IMDCC and CT1+IMDCC compounds exhibit superior corrosion inhibition properties over the entire 18 hour period as compared to the triazole inhibitors. And, unlike the CT1 inhibitor, the IMDCC and CT1+IMDCC compounds do not exhibit any substantial deterioration in corrosion resistance when free chlorine is added.

### Example 3

The classes of compounds and concentrations tested in this example are as shown in Table 6 below.

TABLE 6

| Control | |
|---|---|
| HST | 1 ppm |
| HST | 0.5 ppm |
| HST | 0.25 ppm |
| IMDCC | 2.0 ppm |
| IMDCC | 1 ppm |
| HST + IMDCC | 0.10 ppm + 0.90 ppm |
| HST + IMDCC | 0.25 ppm + 0.75 ppm |
| HST + IMDCC | 0.50 ppm + 0.50 ppm |
| HST + IMDCC | 0.75 ppm + 0.25 ppm |
| HST + IMDCC | 0.90 ppm + 0.10 ppm |
| FAC | 1 ppm |

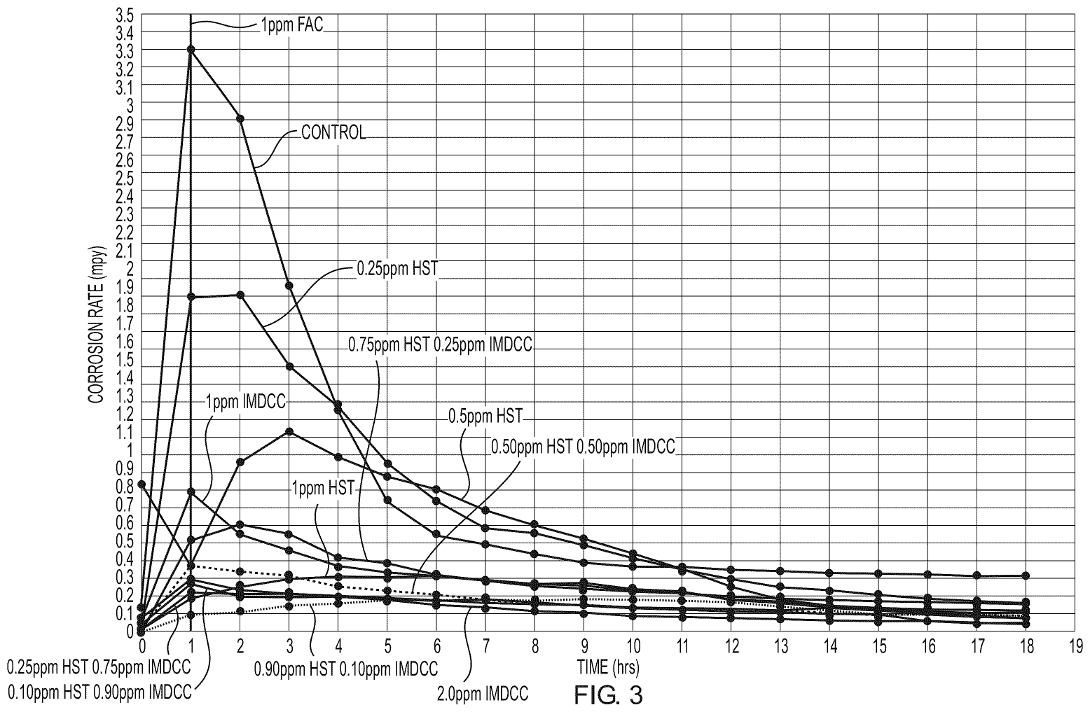

The corrosion rates (in mpy) over the 18 hour period are shown in FIG. 3. As can be seen, the IMDCC and HST+IMDCC compounds exhibit superior corrosion inhibition properties over the entire 18 hour period as compared to the triazole inhibitors. And, unlike the triazole inhibitor, the IMDCC and HST+IMDCC compounds do not exhibit any substantial deterioration in corrosion resistance when free chlorine is added.

### Example 4

The classes of compounds and concentrations tested in this example are as shown in Table 7 below.

TABLE 7

| Control | |
|---|---|
| IMDCC | 2.0 ppm |
| IMDCC | 1 ppm |
| CT2 | 100 ppm |
| CT2 | 50 ppm |
| CT2 | 25 ppm |
| CT2 + IMDCC | 50 ppm + 1 ppm |
| CT2 + IMDCC | 25 ppm + 2 ppm |
| FAC | 1 ppm |

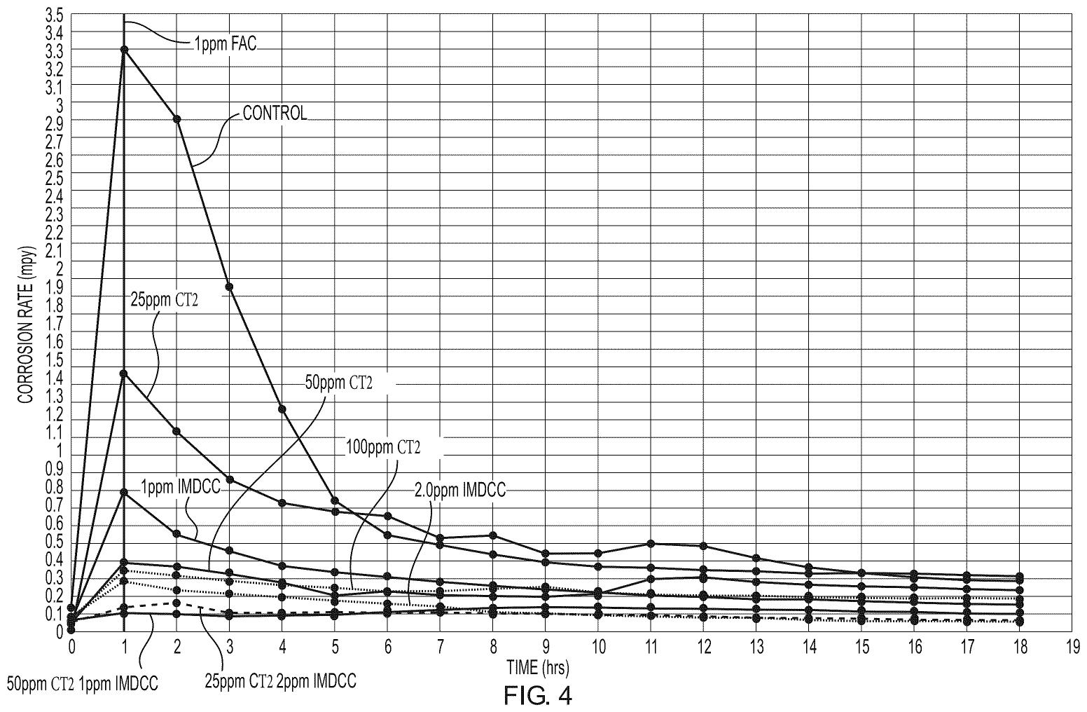

The corrosion rates (in mpy) over the 18 hour period are shown in FIG. 4. As can be seen, the IMDCC and CT2+IMDCC compounds exhibit superior corrosion inhibition properties over the entire 18 hour period as compared to the triazole inhibitors. And, unlike the CT2 inhibitor, the IMDCC and CT2+IMDCC compounds do not exhibit any substantial deterioration in corrosion resistance when free chlorine is added.

It will be appreciated that the above-disclosed features and functions, or alternatives thereof, may be desirably combined into different systems or methods. Also, various alternatives, modifications, variations or improvements may be subsequently made by those skilled in the art. As such, various changes may be made without departing from the spirit and scope of this disclosure.

What is claimed is:

1. A method of inhibiting corrosion of a corrodible metal surface that contacts a water stream in a water system, the method comprising:
introducing into the water stream a treatment composition including at least one light metal corrosion inhibitor, and at least one non-triazole compound that is selected from a compound that is represented by Formula (I) or Formula (II) below: 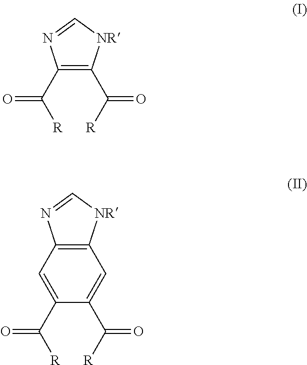
in which R is H, OX, or NX₂, X is H, C₁-C₁₂, Cl, or Br, and R′ is H, Cl, or Br.

2. The method of claim 1, wherein the light metal corrosion inhibitor is selected from the group consisting of Sn, Al, and Zn.

3. The method of claim 1, wherein the water system is a mixed metal system including a yellow metal surface and at least one of a stainless steel surface and a ferrous steel surface.

4. The method of claim 1, wherein the treatment composition excludes a cathodic corrosion inhibitor.

5. The method of claim 1, wherein the at least one non-triazole compound is at least one of a halogenated imidazole and imidazole dicarboxylate.

6. The method of claim 1, wherein the at least one non-triazole compound is at least one of a halogenated benzimidazole and benzimidazole dicarboxylate.

7. The method of claim 1, wherein the at least one non-triazole compound is introduced into the water stream in an amount of from 0.01 ppm to 500 ppm.

8. The method of claim 1, wherein the at least one non-triazole compound is introduced into the water stream in an amount of from 0.1 to 100 ppm.

9. The method of claim 1, wherein the at least one light metal corrosion inhibitor is introduced into the water stream in an amount of from 0.01 ppm to 100 ppm.

10. The method of claim 1, further comprising introducing into the water stream at least one dispersant polymer in an amount of from 0.01 ppm to 10 ppm.

11. The method of claim 1, further comprising introducing into the water stream at least one phosphonate in an amount of from 0.01 ppm to 10 ppm.

12. The method of claim 1, further comprising introducing into the water stream at least one azole compound,
wherein a mass ratio of an amount of the at least one non-triazole compound to the at least one azole compound in the water stream is in a range of 300:1 to 100:1.

13. The method of claim 1, further comprising introducing into the water stream at least one sugar acid in an amount of from 0.01 ppm to 5 ppm.

14. The method of claim 1, further comprising introducing into the water stream at least one of a nitrite, molybdate, silicate, and borate compound in an amount of from 0.01 ppm to 100 ppm.

15. The method of claim 1, further comprising introducing into the water stream a halogen-containing biocide in an amount of at least 0.1 ppm.

16. The method of claim 1, wherein the at least one non-triazole compound is selected from a compound that is represented by Formula (I).

17. A method of inhibiting corrosion of a corrodible metal surface that contacts a water stream in a water system, the method comprising:
introducing into the water stream a treatment composition including at least one non-triazole compound that is selected from a compound that is represented by Formula (I) or Formula (II) below: 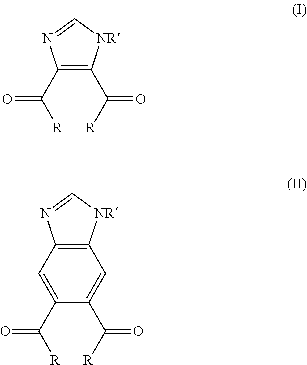
in which R is H, OX, or NX₂, X is H, C₁-C₁₂, Cl, or Br, and R′ is H, Cl, or Br,
wherein the at least one non-triazole compound is solubilized in the treatment composition with potassium hydroxide.

18. The method of claim 17, wherein the treatment composition includes more than 3% of the at least one non-triazole compound solubilized with the potassium hydroxide.

19. The method of claim 17, wherein the at least one non-triazole compound is selected from a compound that is represented by Formula (I).

20. A corrosion inhibition composition comprising:
at least one light metal corrosion inhibitor;
at least one non-triazole compound that is selected from a compound that is represented by Formula (I) or Formula (II) below: 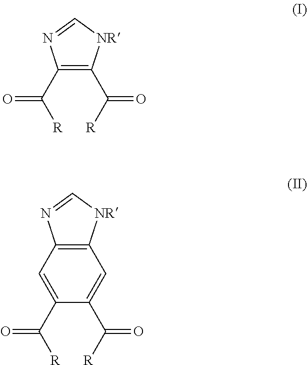
in which R is H, OX, or NX₂, X is H, C₁-C₁₂, Cl, or Br, and R′ is H, Cl, or Br; and
potassium hydroxide,
wherein the at least one non-triazole compound is solubilized in the treatment composition with the potassium hydroxide.

21. The composition according to claim 20, wherein the light metal corrosion inhibitor is selected from the group consisting of Sn, Al, and Zn.

22. The composition according to claim 20, wherein the at least one non-triazole compound is selected from a compound that is represented by Formula (I).
